(19) United States
(12) Patent Application Publication
(10) Pub. No.: US 2025/0106247 A1
(43) Pub. Date: Mar. 27, 2025

(54) SECURITY ORCHESTRATION, AUTOMATION, AND RESPONSE (SOAR) PLAYBOOK GENERATION

(71) Applicant: MICRO FOCUS LLC, Santa Clara, CA (US)

(72) Inventors: Manohar Chamaraju, Bangalore (IN); Vasudevan Gajjala, Bangalore (IN); Sanjay Bhat, Bangalore (IN); Umesh KH, Tumkar (IN)

(73) Assignee: MICRO FOCUS LLC, SANTA CLARA, CA (US)

(21) Appl. No.: 18/372,775

(22) Filed: Sep. 26, 2023

(51) Int. Cl. H04L 9/40; H04L 41/16

(52) U.S. Cl. CPC H04L 63/1483; H04L 41/16

(57) ABSTRACT

A security orchestration, automation, and response (SOAR) playbook is often selected to address an incident, such as a fault or attack (e.g., malware, a phishing attack, etc.) on a computer system or component. However, when the incident is new, manual resolution is often utilized to address the incident. By utilizing a neural network trained to identify similarities in a new incident, the neural network can select a SOAR playbook and optionally automatically deploy the playbook to address the incident.

### FIELD OF THE DISCLOSURE

The invention relates generally to generating and selecting a SOAR playbook to address an incident in a system and particularly to training and utilizing a neural network to select a SOAR playbook for a newly encountered incident.

### BACKGROUND

Security orchestration, automation, and response (SOAR) is a stack of compatible software programs that enables an organization to collect data about security threats and respond to security events with little or no human assistance. The goal of using a SOAR platform is to improve the efficiency of physical and digital security operations.

Prebuilt or customized SOAR playbooks are predefined automated actions. Multiple SOAR playbooks can be connected to complete complex actions. For example, if a malicious URL is found in an employee email and identified during a scan, a playbook can be instituted that blocks the email, alerts the employee of the potential phishing attempt, and blocklists the IP address of the sender. SOAR tools can also trigger follow-up investigative actions by security teams, if necessary. In terms of the phishing example, follow-up could include searching other employee inboxes for similar emails and blocking them and their IP addresses, if found.

### SUMMARY

In prior art solutions, the conditions that trigger a particular SOAR playbook (or more simply, “playbook”) are static. For example, an application programming interface (API) trigger, a Cron trigger, a filter of incidents/events, etc., are triggering events. However, if a new incident is created that does not have a corresponding playbook, an analyst is needed to manually analyze the incident and generate a playbook to handle the incident appropriately. This can be subject to delay waiting for an analyst. Once an analyst becomes available, the task of manually creating a playbook for the new incident is inefficient, time consuming, and error prone.

These and other needs are addressed by the various embodiments and configurations of the present invention. The present invention can provide a number of advantages depending on the particular configuration. These and other advantages will be apparent from the disclosure of the invention(s) contained herein.

In one embodiment, systems and methods are provided that train an artificial intelligence, such as a neural network, to learn how historical incidents, alerts, and/or cases were handled, via playbooks, by one or more tools (e.g., SIEM, XDR, IPS/IDS, etc.). As used herein, learning refers to machine learning techniques to model and understand how specific incidents are handled via playbook. As a result, when a new incident is created, which is not currently associated with any playbook, the trained machine learning systems and methods execute and/or recommend a playbook to address the new incident.

In another embodiment, a machine learning model is made of historical incidents and their associated playbook. Features are extracted from the incidents and corresponding playbooks. A playbook may be converted to a vector to indicate features of the playbook.

In another embodiment, features of incidents and playbooks are combined and trained using the neural network. Training may be performed for all incidents and their associated playbook. Generally, the neural network is trained to hold information about a playbook and playbook nodes, which are executed to remediate the associated incident. Training of the neural network may be performed by an entity, such as a customer, vendor, or software as a service (SAAS) provider, which may utilize training sets that comprise the same or different incidents and/or playbooks and select or execute a playbook for other customers to resolve the incident.

Once the neural network is trained, a new incident is accessed that does not have a corresponding playbook configured. The incident is analyzed by the neural network and a playbook recommended. The recommendation may be automatically implemented, such as when the degree of confidence for the recommendation is above a previously determined threshold. As a further option, the success or failure, or degree thereof, is monitored such as to see if the incident has been removed or if further action is required and, accordingly, such feedback is provided back to the neural network as a training input.

In some aspects, the techniques described herein relate to a computer-implemented method, including: receiving an incident occurring in a system; providing the incident to a neural network trained to select a security orchestration, automation, and response (SOAR) playbook from among a plurality of SOAR playbooks to address the incident, wherein each of the plurality of SOAR playbooks includes a plurality of incident response actions; and automatically executing the selected SOAR playbook.

In some aspects, the techniques described herein relate to a computer-implemented method, further including training the neural network with a plurality of input nodes, wherein the input nodes include aspects of a past incident and a plurality of past output nodes, and wherein each past output node of the plurality of past output nodes corresponds to a past SOAR playbook.

In some aspects, the techniques described herein relate to a computer-implemented method, wherein each past output node of the plurality of past output nodes includes an on-off state, and wherein an on state of the on-off state indicates that the corresponding past output node was executed in the past SOAR playbook and an off state of the on-off state indicates the corresponding past output node was not executed in the past SOAR playbook.

In some aspects, the techniques described herein relate to a computer-implemented method, wherein: the incident includes an attribute selected from at least one of severity, priority, incident type, business impact, risk score, sensor type, affected user type, affected user reputation score, domain name server reputation score, internet protocol address reputation score, outcome, and country of origin; and at least one input node is determined in accordance with the attribute.

In some aspects, the techniques described herein relate to a computer-implemented method, wherein: an action is selected from at least one of create ticket, check uniform resource locator, check for suspicious activity, scan an affected endpoint, block an email sender address, alert security system, close ticket, check domain name server reputation score, and block processing of a task; and at least one output node is determined in accordance with the action.

In some aspects, the techniques described herein relate to a computer-implemented method, wherein: the neural network includes a first neural network trained in a first domain, and a second neural network trained in a second domain different from the first domain; and providing the incident to the neural network further includes determining a best match between the incident and either the first domain or the second domain; and further including providing the incident to either the first domain or the second domain in accordance with the best match and receiving the selected SOAR playbook therefrom.

In some aspects, the techniques described herein relate to a computer-implemented method, wherein the incident includes an incident type selected from at least one of malware, a phishing email, a component performance anomaly, a system error, or a component misconfiguration.

In some aspects, the techniques described herein relate to a computer-implemented method, wherein the neural network is trained including: collecting a set of past incidents, each past incident of the set of past incidents having a corresponding past security orchestration, automation, and response (SOAR) playbook selected as a response thereto; applying one or more transformations to each past incident of the set of past incidents, the one or more transformations including: selecting a different past playbook as the corresponding past playbook, adding a step to the corresponding past playbook, deleting a step from the corresponding past playbook, or altering a step from the corresponding past playbook, to create a set of modified past incidents and, for each modified past incident of the set of modified past incidents, a corresponding modified past playbook; creating a first training set including: (a) the collected set of past incidents and, for each past incident of the collected set of past incidents, the corresponding past playbook, (b) the set of modified past incidents and, for each modified past incident of the set of modified past incidents, the corresponding modified past playbook, and (c) the set of past incidents and, for each past incident of the set of past incidents, a set of known non-corresponding past playbooks; training a neural network in a first stage using the first training set; creating a second training set for a second stage of training including the first training set and the set of known non-corresponding past playbooks that are incorrectly determined as corresponding after the first stage; and training the neural network in the second stage of training using the second training set.

In some aspects, the techniques described herein relate to a system, including: a processor coupled with a computer memory having stored therein instructions that when read cause the processor to perform: collecting a set of past incidents and, each past incident of the set of past incidents having a corresponding past security orchestration, automation, and response (SOAR) playbook selected as a response thereto; applying one or more transformations to each past incident of the set of past incidents, the one or more transformations including: selecting a different past playbook as the corresponding past playbook, adding a step to the corresponding past playbook, deleting a step from the corresponding past playbook, or altering a step from the corresponding past playbook, to create a set of modified past incidents and, for each modified past incident of the set of modified past incidents, a corresponding modified past playbook; creating a first training set including: (a) the collected set of past incidents and, for each past incident of the collected set of past incidents, the corresponding past playbook, (b) the set of modified past incidents and, for each modified past incident of the set of modified past incidents, the corresponding modified past playbook, and (c) the set of past incidents and, for each past incident of the set of past incidents, a set of known non-corresponding past playbooks; training a neural network in a first stage using the first training set; creating a second training set for a second stage of training including the first training set and the set of known non-corresponding past playbooks that are incorrectly determined as corresponding after the first stage; and training the neural network in the second stage of training using the second training set.

In some aspects, the techniques described herein relate to a system, wherein the instructions cause the processor to perform: receiving an incident; providing the incident to the neural network trained to select a security orchestration, automation, and response (SOAR) playbook from among a plurality of SOAR playbooks to address the incident, wherein each of the plurality of SOAR playbooks includes a plurality of incident response actions; and automatically executing the SOAR playbook.

In some aspects, the techniques described herein relate to a system, further including training the neural network with a plurality of input nodes, wherein the input nodes include aspects of a past incident and a plurality of past output nodes, and wherein each past output node of the plurality of past output nodes corresponds to a past SOAR playbook.

In some aspects, the techniques described herein relate to a system, wherein each past output node of the plurality of past output nodes includes an on-off state, and wherein an on state of the on-off state indicates the corresponding past output node was executed in the past SOAR playbook and an off state of the on-off state indicates the corresponding past output node was not executed in the past SOAR playbook.

In some aspects, the techniques described herein relate to a system, wherein: the incident includes an attribute selected from at least one of severity, priority, incident type, business impact, risk score, sensor type, affected user type, affected user reputation score, domain name server reputation score, internet protocol address reputation score, outcome, and country of origin; and at least one input node is determined in accordance with the attribute.

In some aspects, the techniques described herein relate to a system, including: a processor coupled with a computer memory having stored therein instructions that when read cause the processor to perform: receiving an incident occurring in the system; providing the incident to a neural network trained to select a security orchestration, automation, and response (SOAR) playbook from among a plurality of SOAR playbooks to address the incident, wherein each of the plurality of SOAR playbooks includes a plurality of incident response actions; and automatically executing the selected SOAR playbook.

In some aspects, the techniques described herein relate to a system, wherein the instructions cause the processor to perform training the neural network with a plurality of input nodes, wherein the input nodes include aspects of a past incident and a plurality of past output nodes, and wherein each past output node of the plurality of past output nodes corresponds to a past SOAR playbook.

In some aspects, the techniques described herein relate to a system, wherein each past output node of the plurality of past output nodes includes an on-off state, and wherein an on state of the on-off state indicates that the corresponding past output node was executed in the past SOAR playbook and an off state of the on-off state indicates the corresponding past output node was not executed in the past SOAR playbook.

In some aspects, the techniques described herein relate to a system, wherein: the incident includes an attribute selected from at least one of severity, priority, incident type, business impact, risk score, sensor type, affected user type, affected user reputation score, domain name server reputation score, internet protocol address reputation score, outcome, and country of origin; and at least one input node is determined in accordance with the attribute.

In some aspects, the techniques described herein relate to a system, wherein: an action is selected from at least one of create ticket, check uniform resource locator, check for suspicious activity, scan an affected endpoint, block an email sender address, alert security system, close ticket, check domain name server reputation score, and block processing of a task; and at least one output node is determined in accordance with the action.

In some aspects, the techniques described herein relate to a system, wherein: the neural network includes a first neural network trained in a first domain, and a second neural network trained in a second domain different from the first domain; providing the incident to the neural network further includes determining a best match between the incident and either the first domain or the second domain; and further providing the incident to either the first domain or the second domain in accordance with the best match and receiving the selected SOAR playbook therefrom.

In some aspects, the techniques described herein relate to a system, wherein the incident includes an incident type selected from at least one of malware, a phishing email, a component performance anomaly, a system error, or a component misconfiguration.

A system on a chip (SoC) including any one or more of the above aspects or aspects of the embodiments described herein.

One or more means for performing any one or more of the above aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a neural network in accordance with embodiments of the present disclosure;

FIG. 3 depicts a process in accordance with embodiments of the present disclosure;

FIG. 4 depicts a process in accordance with embodiments of the present disclosure; and

FIG. 5 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

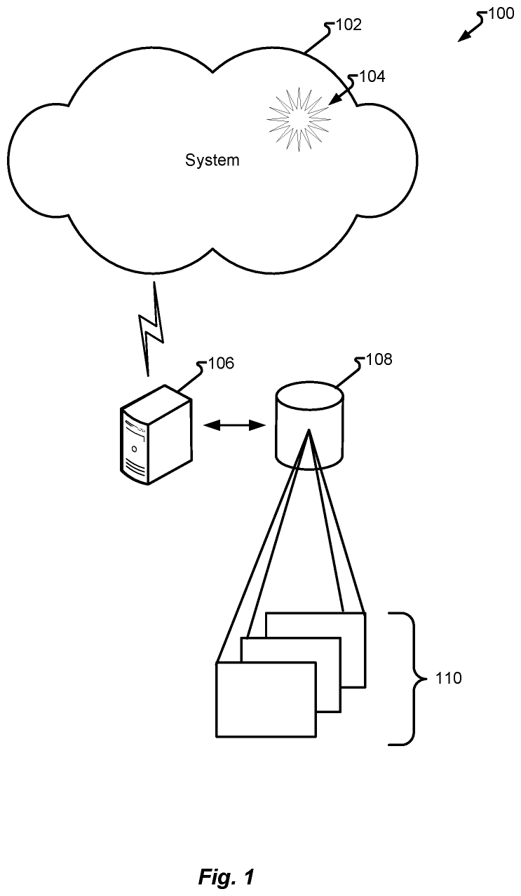

FIG. 1 depicts monitoring system 100 in accordance with embodiments of the present disclosure. In one embodiment, monitoring system 100 comprises system 102. System 102 is variously embodied and may include one or more types and instances of computer, data storage, and networking hardware and software. Examples of the elements (not shown) within system 102 include, but are not limited to, workstations, routers, switches, file servers, web servers, mail servers, data storage devices, network interfaces, etc.

System 102 may encounter instance 104, which poses a risk to hardware, software, and/or data and the usage thereof. Instance 104 may comprise a threat (e.g., virus, malware, phishing, etc.), fault, defect, misconfiguration, risk, or deviation from the desired state of system 102 and the components and operations therein.

System 102 may be monitored by server 106. Server 106 may be a portion of or external to system 102. Server 106 may be embodied as one or more components (hardware and software) distributed between components internal and/or external to system 102. Similarly, system 102 may comprise database 108, which may also be embodied as components internal, external, or a combination thereof, to system 102.

In one embodiment, server 106 accesses, receives, detects, or otherwise becomes aware of instance 104. Server 106 may receive instance 104 itself, such as a phishing email received at an email server or address of system 102, or indicia of instance 104, such as an operational pattern or a signature of a malware agent operating within system 102. In another embodiment, server 106 may receive a notification of instance 104, such as a new or existing user who is not properly configured to utilize the resources of system 102 or a trouble ticket, such as a print server that is misconfigured or has failed.

Database 108 may maintain playbooks 110, such as SOAR playbooks. Server 106 analyzes instance 104 (itself and/or indicia thereof) and determines if instance 104 is known and associated with a particular one of playbooks 110. An exact match is true if the type and/or operation of instance 104 is known and associated with the particular one of playbooks 110. For example, instance 104 may be an unsolicited email (i.e., spam). Spam emails may differ, such as their content or sender, but once an email is identified by server 106 as spam, a match to the particular spam playbook of playbooks 110 is made. The selected playbook is then executed to process the spam, such as to block the sending address and deleting the unsolicited email.

In another embodiment, an exact match between known instances and instance 104 or between instance 104 and playbooks 110 may not be determined. For example, instance 104 may be insufficiently similar to known instances and/or corresponding playbooks 110. For example, a known malware attack may have mutated to perform a new action. Additionally or alternatively, instance 104 may be entirely unknown to server 106 and playbooks 110. When instance 104 is unknown, embodiments herein utilize a trained neural network to determine the nodes of a new playbook to execute to resolve instance 104 when new or unknown.

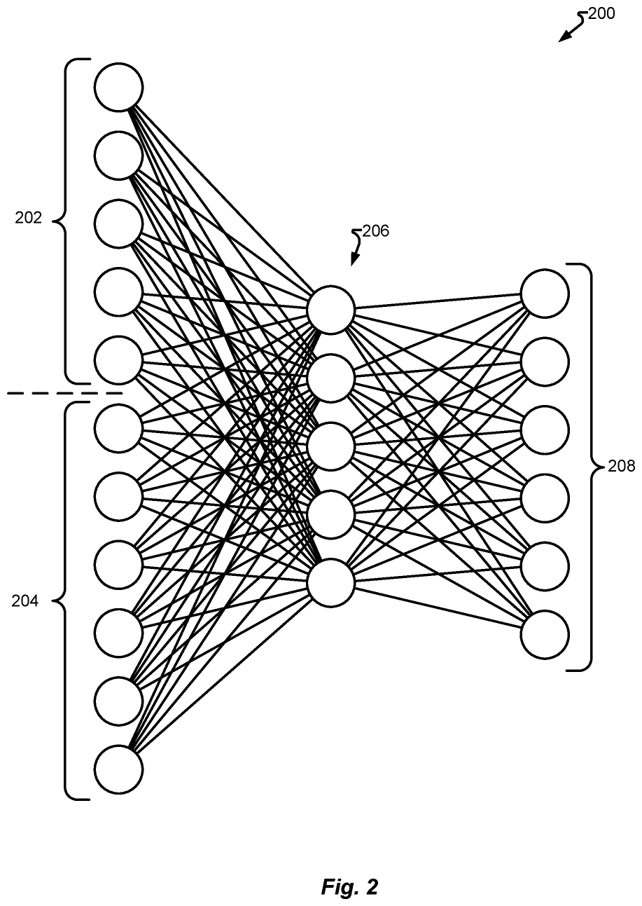

FIG. 2 depicts neural network 200 in accordance with embodiments of the present disclosure. A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., a hyperplane) to delineate a combination of inputs that are active or inactive.

In one embodiment, neural network 200 comprises input nodes, namely, incident feature nodes 202 and playbook nodes 204 mapped to processing nodes 206 which, in turn, are mapped to playbook nodes 208. Processing nodes 206, which may be hidden nodes, receive values from incident feature nodes 202, which comprise features for a particular incident, such as instance 104 (see FIG. 1). Input nodes 202 comprise a number of nodes based on a previously determined set of features for an incident. For example, a phishing email may have a severity node, a sender node, a recipient node, a subject matter node, etc., each having a value calculated from existing methodologies. For example, a recipient node may have a lower score if sent to an entry-level worker, whereas the recipient node may be higher if sent to the president of the company. In another example, the priority node may be higher if the phishing email is attempting to get recipients to provide confidential information on a malicious website that resembles the company website. The priority may be lower if the malicious website was unrelated to the company and users are (or should be) already suspicious of such websites and, as a result, on their own accord do not visit, or at least do not provide confidential information to, such a website. Node values may be converted to vectors. The vectors may be integer or floating-point numbers (such as to indicate a type-plus-severity or other attribute-plus-score) or string vectors, which can be indexed or encode other features. Incidences are generally occurrences, as observed or recorded in a computer memory, that may have one or more attributes. The attributes may be one or more of priority, severity, incident type (e.g., spam, phishing, malware, anomaly, system error, etc.), business impact, risk score, sensor type (e.g., unusual traffic, unusual traffic volume, etc.), affected user type (e.g., CEO, security personnel, administrative, etc.), affected user reputation score, domain name server reputation score, internet protocol address reputation score, outcome, and country of origin.

Feature nodes may have a value, such as a null value, if the node is not applicable. In such embodiments, neural network 200 may be utilized for different types of incidents (e.g., phishing emails and onboarding new employees) as irrelevant feature nodes are merely “null.” In other embodiments, two or more neural networks may each be directed to a particular category of instances. For example, onboarding new employees may have nodes related to file server access, email account, building access, etc., which are unrelated to phishing emails. As a result, more than one trained neural network may specialize in a particular category or subject matter domain and have fewer null nodes, and a best match to the particular subject matter domain is selected and utilized.

Processing nodes 206 receive input values from playbook nodes 204. In one embodiment, playbook nodes 204 have a one-to-one correspondence with playbook nodes 208. Playbook nodes 208 determined to be “1” or “on” are true and correspond to performing the corresponding operations of the playbook. Playbook nodes 208 determined to be “0” or “off” are false and correspond to omitting the corresponding operations of the playbook. A playbook may be an ordered collection of operation, and the completion of one operation may trigger (turn from “off” to “on”) a playbook node 208 to perform another operation.

The number of playbook nodes 204 and playbook processing nodes 206 are determined by the number of playbook operations. To avoid unnecessarily complicating the figure, neural network 200 is illustrated with six nodes. However, for a playbook with more or fewer operations, a corresponding number of playbook nodes may be used. For example, for a phishing incident, playbook nodes 204 and playbook processing nodes 206 may comprise twelve nodes, such as create ticket, check uniform resource locator (URL), check if suspicions, scan endpoint, block email, alert employee, lock user, block process, email to manager, IP score, check DNS blacklisting, and close ticket. The “close ticket” node, if “on,” indicates the playbook has ended and that the ticket is to be closed.

In another embodiment, playbook nodes 208 will comprise a score. For example, scores may be a value between zero and one. A value between 0.500 and 1.000 may indicate true, whereas a value of 0.000 and 0.499 may indicate false. If a value is true and above a previously determined threshold, such as one indicating a sufficiently high degree of confidence, the corresponding operation of the playbook may be automatically performed. If a value is true but below the previously determined threshold, then the corresponding operation may be recommended and presented for further analysis or human approval. Similarly, if a value is false with a lower than previously determined threshold value, the corresponding operation is automatically excluded. If the value is not lower than the threshold, the operation may be presented to a human as a potential, but not recommended, operation. If two or more nodes within the same iteration are true (or sufficiently so), both corresponding operations may be performed.

In another embodiment, each iteration produces a set of true-false (or on-off, etc.) values in playbook nodes 208. Each set of true-false values are then used to set values of playbook nodes 204. This may result in the stepwise performance of the operations of the playbook or, alternatively, steps may be repeated or omitted, in accordance with playbook nodes 204 and incident nodes 202.

In another embodiment, an iterative training phase of neural network 200 is provided to generate a new playbook. The iterative training phase may be provided for each incident type and playbook combination. In each iteration, incident features are determined and provided as feature nodes 202 and a SOAR playbook are used as inputs via mapping to playbook nodes 204. The resulting output layer values then result in playbook nodes 208, for one iteration. At one of playbook nodes 208 will be targeted have a value of “1” (or less than “1” but greater than a previously determined threshold indicative of “1”), as determined by the logic of processing nodes of 206, and then utilized as an input for the next iteration. The targeting of one of the playback nodes 208 is a feed-forward wherein selected (or deselected) one or more of feature nodes 202 of the incident that produce the desired targeted one of the playbook nodes 208. Nodes of playbook nodes 208 that result in “0” (or greater than “0” but less than a previously determined threshold indicative of “0”) will be omitted as inputs for the next iteration. As a result, neural network 200 is then trained for the steps to produce a specific output of one iteration. The specific output is then reintroduced as the input along with the incident features for the next iteration. The iterations repeat until the output is “close ticket” or other conclusion that the playbook is complete.

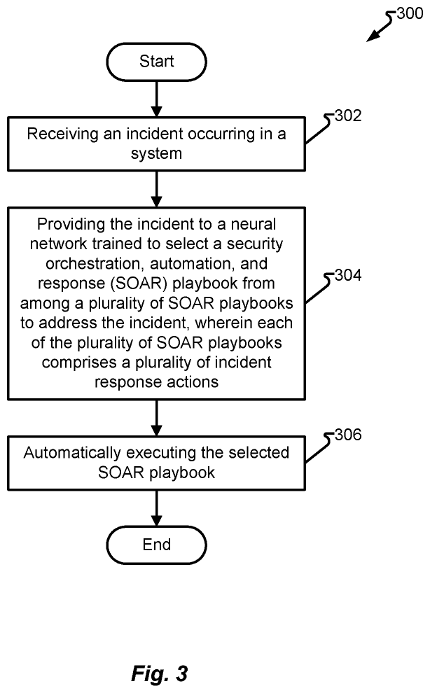

FIG. 3 depicts process 300 in accordance with embodiments of the present disclosure. In one embodiment, process 300 is embodied as machine-readable instructions maintained in a non-transitory memory that when read by a machine, such as processors of a server, cause the machine to execute the instructions and thereby execute process 300. The processor of the server may include, but is not limited to, at least one processor of server 106.

In one embodiment, process 300 begins and, in step 302, receives an incident occurring in a system, such as instance 104 occurring in system 102 being received, known, alerted, detected, or otherwise presented (instance 104 or indica of instance 104) to server 106. Step 304 provides the incident to a neural network trained to select a security orchestration, automation, and response (SOAR) playbook from among a plurality of SOAR playbooks to address the incident, wherein each of the plurality of SOAR playbooks comprises a plurality of incident response actions. Step 306 automatically executes the selected SOAR playbook.

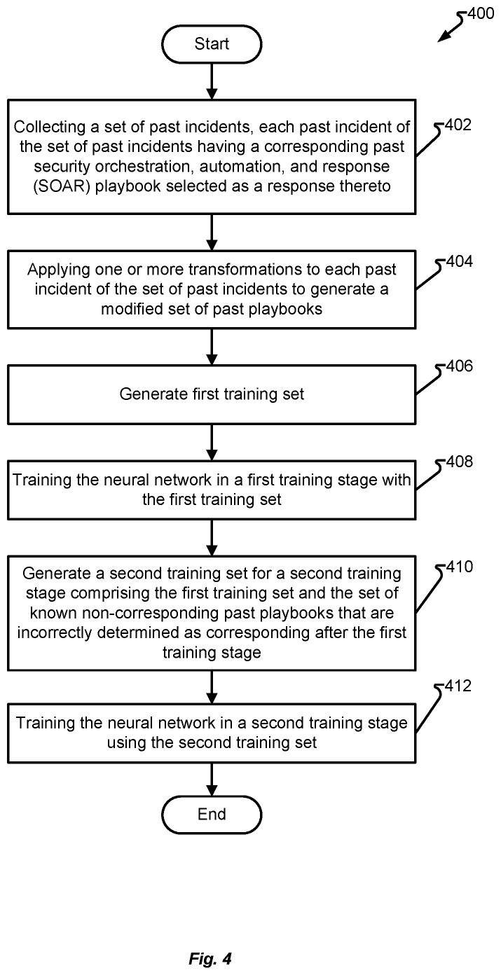

FIG. 4 depicts process 400 in accordance with embodiments of the present disclosure. In one embodiment, process 400 begins and, in step 402, a set of past incidents is collected, each past incident of the set of past incidents having a corresponding past security orchestration, automation, and response (SOAR) playbook selected as a response thereto.

Step 404 applies one or more transformations to each past incident of the set of past incidents, the one or more transformations including: selecting a different past playbook as the corresponding past playbook, adding a step to the corresponding past playbook, deleting a step from the corresponding past playbook, or altering a step from the corresponding past playbook, to generate a set of modified past playbooks and, for each modified past incident of the set of modified past incidents, a corresponding modified past playbook.

Step 406 generates a first training set comprising: (a) the collected set of past incidents and, for each past incident of the collected set of past incidents, the corresponding past playbook, (b) the set of modified past incidents and, for each modified past incident of the set of modified past incidents, the corresponding modified past playbook, and (c) the set of past incidents and, for each past incident of the set of past incidents, a set of known non-corresponding past playbooks.

Step 408 trains a neural network in a first training stage using the first training set.

Step 410 generates a second training set for a second training stage comprising the first training set and the set of known non-corresponding past playbooks that are incorrectly determined as corresponding after the first training stage.

Step 412 trains the neural network in the second training stage using the second training set.

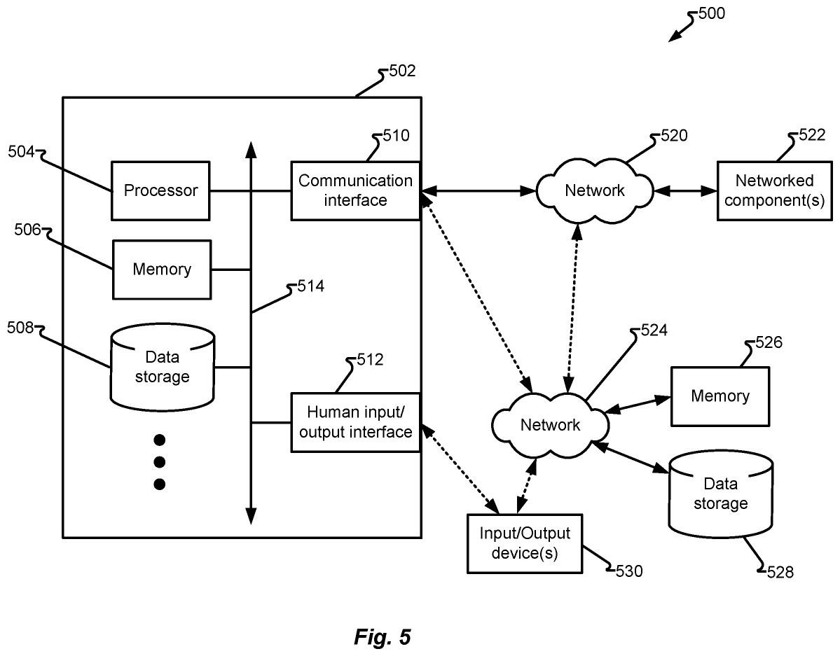

FIG. 5 depicts device 502 in system 500 in accordance with embodiments of the present disclosure. The components of device 502 are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, computer memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize computer memory 506 and/or data storage 508 for the storage of accessible data, such as instructions, values, etc. Communication interface 510 facilitates communication with components, such as processor 504 via bus 514 with components not accessible via bus 514 and may be embodied as a network interface (e.g., ethernet card, wireless networking components, USB port, etc.). Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.).

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) than networked components 522, which may be connected to network 520 comprising a public network (e.g., Internet) that may not be as trusted.

Components attached to network 524 may include computer memory 526, data storage 528, input/output device(s) 530, and/or other components that may be accessible to processor 504. For example, computer memory 526 and/or data storage 528 may supplement or supplant computer memory 506 and/or data storage 508 entirely or for a particular task or purpose. As another example, computer memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via network interface 510 either directly, via network 524, via network 520 alone (not shown), or via networks 524 and 520. Each of computer memory 506, data storage 508, computer memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, a switch, a port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. The methods or processes described herein are computer-implemented or other machine-based process. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A computer-implemented method, comprising:
receiving an incident occurring in a system;
providing the incident to a neural network trained to select a security orchestration, automation, and response (SOAR) playbook from among a plurality of SOAR playbooks to address the incident, wherein each of the plurality of SOAR playbooks comprises a plurality of incident response actions; and
automatically executing the selected SOAR playbook.

2. The computer-implemented method of claim 1, further comprising training the neural network with a plurality of input nodes, wherein the input nodes comprise aspects of a past incident and a plurality of past output nodes, and wherein each past output node of the plurality of past output nodes corresponds to a past SOAR playbook.

3. The computer-implemented method of claim 2, wherein each past output node of the plurality of past output nodes comprises an on-off state, and wherein an on state of the on-off state indicates that the corresponding past output node was executed in the past SOAR playbook and an off state of the on-off state indicates the corresponding past output node was not executed in the past SOAR playbook.

4. The computer-implemented method of claim 2, wherein:
the incident comprises an attribute selected from at least one of severity, priority, incident type, business impact, risk score, sensor type, affected user type, affected user reputation score, domain name server reputation score, internet protocol address reputation score, outcome, and country of origin; and
at least one input node is determined in accordance with the attribute.

5. The computer-implemented method of claim 2, wherein:
an action is selected from at least one of create ticket, check uniform resource locator, security system, close ticket, check domain name server reputation score, and block processing of a task; and
at least one output node is determined in accordance with the action.

6. The computer-implemented method of claim 1, wherein:
the neural network comprises a first neural network trained in a first domain, and a second neural network trained in a second domain different from the first domain; and
providing the incident to the neural network further comprises determining a best match between the incident and either the first domain or the second domain; and
further comprising providing the incident to either the first domain or the second domain in accordance with the best match and receiving the selected SOAR playbook therefrom.

7. The computer-implemented method of claim 1, wherein the incident comprises an incident type selected from at least one of malware, a phishing email, a component performance anomaly, a system error, or a component misconfiguration.

8. The computer-implemented method of claim 1, wherein the neural network is trained comprising:
collecting a set of past incidents, each past incident of the set of past incidents having a corresponding past security orchestration, automation, and response (SOAR) playbook selected as a response thereto;
applying one or more transformations to each past incident of the set of past incidents, the one or more transformations including: selecting a different past playbook as the corresponding past playbook, adding a step to the corresponding past playbook, deleting a step from the corresponding past playbook, or altering a step from the corresponding past playbook, to generate a set of modified past incidents and, for each modified past incident of the set of modified past incidents, a corresponding modified past playbook;
creating a first training set comprising: (a) the collected set of past incidents and, for each past incident of the collected set of past incidents, the corresponding past playbook, (b) the set of modified past incidents and, for each modified past incident of the set of modified past incidents, the corresponding modified past playbook, and (c) the set of past incidents and, for each past incident of the set of past incidents, a set of known non-corresponding past playbooks;
training a neural network in a first stage using the first training set;
creating a second training set for a second stage of training comprising the first training set and the set of known non-corresponding past playbooks that are incorrectly determined as corresponding after the first stage; and
training the neural network in the second stage of training using the second training set.

9. A system, comprising:
a processor coupled with a computer memory having stored therein instructions that when read cause the processor to perform:
collecting a set of past incidents and, each past incident of the set of past incidents having a corresponding past security orchestration, automation, and response (SOAR) playbook selected as a response thereto;
applying one or more transformations to each past incident of the set of past incidents, the one or more transformations including: selecting a different past playbook as the corresponding past playbook, adding a step to the corresponding past playbook, deleting a step from the corresponding past playbook, or altering a step from the corresponding past playbook, to generate a set of modified past incidents and, for each modified past incident of the set of modified past incidents, a corresponding modified past playbook;
creating a first training set comprising: (a) the collected set of past incidents and, for each past incident of the collected set of past incidents, the corresponding past playbook, (b) the set of modified past incidents and, for each modified past incident of the set of modified past incidents, the corresponding modified past playbook, and (c) the set of past incidents and, for each past incident of the set of past incidents, a set of known non-corresponding past playbooks;
training a neural network in a first stage using the first training set;
creating a second training set for a second stage of training comprising the first training set and the set of known non-corresponding past playbooks that are incorrectly determined as corresponding after the first stage; and
training the neural network in the second stage of training using the second training set.

10. The system of claim 9, wherein the instructions cause the processor to perform:
receiving an incident;
providing the incident to the neural network trained to select a security orchestration, automation, and response (SOAR) playbook from among a plurality of SOAR playbooks to address the incident, wherein each of the plurality of SOAR playbooks comprises a plurality of incident response actions; and
automatically executing the SOAR playbook.

11. The system of claim 9, further comprising training the neural network with a plurality of input nodes, wherein the input nodes comprise aspects of a past incident and a plurality of past output nodes, and wherein each past output node of the plurality of past output nodes corresponds to a past SOAR playbook.

12. The system of claim 11, wherein each past output node of the plurality of past output nodes comprises an on-off state, and wherein an on state of the on-off state indicates the corresponding past output node was executed in the past SOAR playbook and an off state of the on-off state indicates the corresponding past output node was not executed in the past SOAR playbook.

13. The system of claim 11, wherein:
the incident comprises an attribute selected from at least one of severity, priority, incident type, business impact, risk score, sensor type, affected user type, affected user reputation score, domain name server reputation score, internet protocol address reputation score, outcome, and country of origin; and
at least one input node is determined in accordance with the attribute.

14. A system, comprising:
a processor coupled with a computer memory having stored therein instructions that when read cause the processor to perform:
receiving an incident occurring in the system;
providing the incident to a neural network trained to select a security orchestration, automation, and response (SOAR) playbook from among a plurality of SOAR playbooks to address the incident, wherein each of the plurality of SOAR playbooks comprises a plurality of incident response actions; and
automatically executing the selected SOAR playbook.

15. The system of claim 14, wherein the instructions cause the processor to perform training the neural network with a plurality of input nodes, wherein the input nodes comprise aspects of a past incident and a plurality of past output nodes, and wherein each past output node of the plurality of past output nodes corresponds to a past SOAR playbook.

16. The system of claim 15, wherein each past output node of the plurality of past output nodes comprises an on-off state, and wherein an on state of the on-off state indicates that the corresponding past output node was executed in the past SOAR playbook and an off state of the on-off state indicates the corresponding past output node was not executed in the past SOAR playbook.

17. The system of claim 15, wherein:
the incident comprises an attribute selected from at least one of severity, priority, incident type, business impact, risk score, sensor type, affected user type, affected user reputation score, domain name server reputation score, internet protocol address reputation score, outcome, and country of origin; and
at least one input node is determined in accordance with the attribute.

18. The system of claim 15, wherein:
an action is selected from at least one of create ticket, check uniform resource locator, security system, close ticket, check domain name server reputation score, and block processing of a task; and
at least one output node is determined in accordance with the action.

19. The system of claim 14, wherein:
the neural network comprises a first neural network trained in a first domain, and a second neural network trained in a second domain different from the first domain;
providing the incident to the neural network further comprises determining a best match between the incident and either the first domain or the second domain; and
further providing the incident to either the first domain or the second domain in accordance with the best match and receiving the selected SOAR playbook therefrom.

20. The system of claim 14, wherein the incident comprises an incident type selected from at least one of malware, a phishing email, a component performance anomaly, a system error, or a component misconfiguration.
